(19) United States
(12) Patent Application Publication
(10) Pub. No.: US 2012/0073614 A1
(43) Pub. Date: Mar. 29, 2012

(54) ENDOSCOPE CLEANING SYSTEM AND ENDOSCOPE CLEANING METHOD

(75) Inventors: Kenichi Otani, Ashigarakami-gun (JP); Mitsuhiko Serizawa, Ashigarakami-gun (JP); Kazuya Takeuchi, Ashigarakami-gun (JP); Seiichi Yamamoto, Ashigarakami-gun (JP); Nobuyuki Torisawa, Ashigarakami-gun (JP); Hirofumi Katsura, Ashigarakami-gun (JP); Maki Saito, Ashigarakami-gun (JP); Shozo Iyama, Ashigarakami-gun (JP); Issei Suzuki, Ashigarakami-gun (JP); Yasunori Ohta, Ashigarakami-gun (JP); Yasuyuki Hosono, Ashigarakami-gun (JP)

(73) Assignee: FUJIFILM CORPORATION, Tokyo (JP)

(21) Appl. No.: 13/244,422

(22) Filed: Sep. 24, 2011

(30) Foreign Application Priority Data
Sep. 29, 2010 (JP) JP 2010-219546
Sep. 29, 2010 (JP) JP 2010-219547

(51) Int. Cl. B08B 7/04

(52) U.S. Cl. 134/56 R

(57) ABSTRACT

An endoscope cleaning system of one aspect of the subject matter includes: a first cleaning device configured to clean an endoscope; a second cleaning device configured to clean the endoscope according to a method different from that of the first cleaning device; and a cleaning evaluation device configured to determine whether or not a cleaning level of the endoscope cleaned by one of the first cleaning device and the second cleaning device satisfies a predetermined criterion, wherein one of the first cleaning device and the second cleaning device cleans the endoscope in accordance with a determination result of the cleaning evaluation device.

### BACKGROUND OF THE INVENTION

1. Field of the Invention

The presently disclosed subject matter relates to an endoscope cleaning system and an endoscope cleaning method, and more particularly, to an endoscope cleaning system and an endoscope cleaning method that can reliably secure a cleaning level of an endoscope.

2. Description of the Related Art

An endoscope is known as medical equipment used for examination or treatment of the inside of a living body cavity. The endoscope includes an insertion part to be inserted into the body cavity. The insertion part is a flexible bar-like member and includes: a photographing unit that photographs the inside of the body cavity; and various channels (hereinafter, also referred to as endoscope conduits) such as a forceps channel through which a treatment tool is inserted. Body fluids and waste substances are attached to an outer surface of the insertion part and each channel provided inside of the insertion part of the endoscope after use. Disease germs and viruses contained in the body fluids and the waste substances cause hospital infections, and hence the endoscope after use is always cleaned and disinfected.

An endoscope cleaning and disinfecting apparatus is utilized in order to efficiently clean and disinfect the endoscope. In the endoscope cleaning and disinfecting apparatus, the endoscope after use is housed in a cleaning bath and is automatically subjected to a cleaning step, a disinfection step, and a rinsing step.

In the cleaning step, the body fluids and the waste substances attached to the outer surface and each channel are washed away by injecting water, a cleaning agent, or other substance to the endoscope. The water used in the cleaning step is discharged to the outside of the endoscope cleaning and disinfecting apparatus. In the disinfection step, the endoscope is immersed in a disinfectant solution, and disease germs and viruses that have not been removed in the cleaning step are removed or their pathogenicity is eliminated. The disinfectant solution used in the disinfection step is returned to a disinfectant solution tank in which the disinfectant solution is reserved. The rinsing step is performed after the cleaning step and the disinfection step, and in this step, the water after cleaning or the disinfectant solution attached to the endoscope is rinsed with pure water.

In this regard, Japanese Patent Application Laid-Open No. 2009-195554 discloses a technique for evaluating whether or not the cleaning and disinfection process of the endoscope is appropriately performed. Specifically, after the endoscope after use is cleaned and disinfected by the endoscope cleaning and disinfecting apparatus, a separating solution is poured into the endoscope conduit, and bacteria contained in the separating solution are captured by a filter. Then, the captured bacteria are cultured to be observed, whereby the quality (cleanliness) of the endoscope conduit is evaluated.

### SUMMARY OF THE INVENTION

Unfortunately, the conventional endoscope cleaning and disinfecting apparatus does not perform quality evaluation for the endoscope, and hence cleaning and disinfection may be excessively performed in some cases in order to obtain a sufficient effect in a single process, resulting in an increase in costs. In such cases, the endoscope may be damaged, so that the service life of the endoscope may be shortened.

In view of this problem, Japanese Patent Application Laid-Open No. 2009-195554 discloses as described above the technique for evaluating whether or not the cleaning and disinfection process of the endoscope is appropriately performed, but makes no specific disclosure as to what kind of process is performed when the evaluated quality is determined to be insufficient.

In addition, a large part of moist substances such as a mucous membrane and blood is removed by cleaning, and after that, infectious organisms are sterilized by the subsequent disinfection, whereby effective disinfection can be achieved. That is, in order to obtain an effect of the disinfectant solution, the cleaning level in the previous step is important, but Japanese Patent Application Laid-Open No. 2009-195554 makes no consideration of performing cleaning evaluation on the endoscope after the cleaning.

The presently disclosed subject matter has been made in view of the above-mentioned circumstances, and therefore has an object to provide an endoscope cleaning system and an endoscope cleaning method that can reliably secure the cleaning level of an endoscope, to thereby obtain a sufficient disinfection effect.

In order to achieve the above-mentioned object, the presently disclosed subject matter provides an endoscope cleaning system including: a first cleaning device configured to clean an endoscope; a second cleaning device configured to clean the endoscope according to a method different from that of the first cleaning device; and a cleaning evaluation device configured to determine whether or not a cleaning level of the endoscope cleaned by one of the first cleaning device and the second cleaning device satisfies a predetermined criterion. One of the first cleaning device and the second cleaning device cleans the endoscope in accordance with a determination result of the cleaning evaluation device.

According to the presently disclosed subject matter, the cleaning evaluation is performed for determining whether or not the cleaning level of the endoscope after the cleaning satisfies the predetermined criterion, and the endoscope is re-cleaned in accordance with the determination result. Accordingly, even in the case where the cleaning of the endoscope is insufficient, contamination attached to the endoscope can be reliably removed, while excessive cleaning of the endoscope is prevented. This makes it possible to reliably secure the cleaning level of the endoscope, and a sufficient effect can be obtained in the subsequent disinfection.

### BRIEF DESCRIPTION OF THE DRAWINGS

FIG. 1 is a schematic configuration diagram illustrating an endoscope cleaning system according to an embodiment of the presently disclosed subject matter;

FIG. 2 is a block diagram illustrating an electrical configuration of a cleaning apparatus;

FIG. 3 is a flow chart illustrating a first operation example of the cleaning apparatus;

FIG. 4 is a flow chart illustrating a second operation example of the cleaning apparatus;

FIG. 5 is a flow chart illustrating a third operation example of the cleaning apparatus;

FIG. 6 is a table illustrating an example of a correspondence relation between a number of times of cleaning and an endoscope-usable time length;

FIG. 7 is a flow chart illustrating an operation example of an endoscope processor;

FIG. 8 is a flow chart illustrating a fourth operation example of the cleaning apparatus;

FIG. 9 is a table illustrating an example of a correspondence relation between the number of times of cleaning and the number of times of re-cleaning;

FIG. 10 is a flow chart illustrating a fifth operation example of the cleaning apparatus;

FIG. 11 is a flow chart illustrating a sixth operation example of the cleaning apparatus;

FIG. 12 is a flow chart illustrating a seventh operation example of the cleaning apparatus;

FIG. 13 is a diagram illustrating an example of a determination table for determining whether or not a first cleaning process is to be performed, in accordance with the numbers of times of previous cleaning; and

FIG. 14 is a flow chart illustrating an eighth operation example of the cleaning apparatus.

### DETAILED DESCRIPTION OF THE PREFERRED EMBODIMENTS

Hereinafter, preferred embodiments of the presently disclosed subject matter are described in detail with reference to the attached drawings.

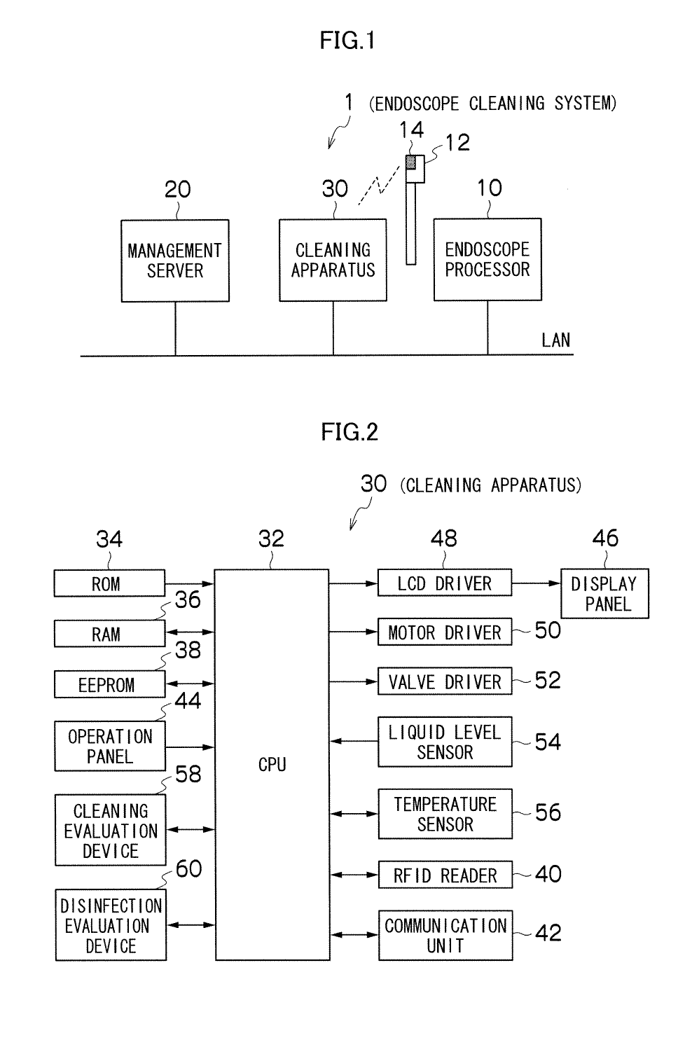

FIG. 1 is a schematic configuration diagram illustrating an endoscope cleaning system according to an embodiment of the presently disclosed subject matter. As illustrated in FIG. 1, an endoscope cleaning system 1 of the present embodiment includes an endoscope processor 10, a cleaning history management server (hereinafter, simply referred to as “management server”) 20, and an endoscope cleaning and disinfecting apparatus (hereinafter, simply referred to as “cleaning apparatus”) 30.

These apparatuses such as the endoscope processor 10, the management server 20, and the cleaning apparatus 30 are connected to one another via, for example, a network such as an in-hospital LAN (local area network), and can exchange data with one another. Note that, the respective apparatuses do not necessarily need to be connected to one another via the LAN, and alternatively, the respective apparatuses may exchange data with one another through direct communication. At this time, it is not necessary to establish communication among all the apparatuses, and it is sufficient to establish communication at least between the management server 20 and the endoscope processor 10 and between the management server 20 and the cleaning apparatus 30.

Note that, in FIG. 1, the number of each of an endoscope 12, the endoscope processor 10, and the cleaning apparatus 30 is only one, but may be more than one.

In general, the endoscope processor 10 is installed in an examination room in which endoscopic examination is performed, and the cleaning apparatus 30 is installed in a cleaning room in which cleaning of the endoscope 12 is performed. In addition, the endoscope 12 before the endoscopic examination is kept in a depository. When the endoscopic examination is performed, the endoscope 12 is carried out of the depository to be connected to the endoscope processor 10 in the examination room, and then, the examination is performed. At this time, the endoscope processor 10 may also be kept in the depository, and may be carried out thereof together with the endoscope 12 to be used in the examination room. After the end of the examination, the endoscope 12 is detached from the endoscope processor 10, is carried to the cleaning room, and is cleaned by the cleaning apparatus 30. The endoscope 12 after the cleaning is kept in the depository.

The endoscope 12, which is not illustrated in detail, includes: an insertion part to be inserted into a body cavity; and an operation part that is provided so as to be continuous with a base end of the insertion part and functions also as a grip part. A photographing unit including a CCD (charge-coupled device) and other members is built at a leading end of the insertion part, and the photographing unit photographs a region to be observed inside of the body cavity. Then, at the time of examination, the endoscope 12 is connected to the endoscope processor 10, and the endoscopic examination is performed. At this time, the endoscope 12 is detachably connected to the endoscope processor 10 and an illuminating apparatus (not illustrated) provided next to the endoscope processor 10, via a connector provided at a leading end of a code that extends from a side wall of the operation part of the endoscope 12.

In addition, the endoscope 12 includes a radio frequency identification (RFID) tag 14. The RFID tag 14 enables the endoscope 12 to exchange information with the respective apparatuses or a mobile terminal held by an operator, and also enables the endoscope 12 to be individually identified. The RFID tag 14 includes: an IC (integrated circuit) chip that stores therein an ID of the endoscope 12 (identification information specific to each endoscope); and a loop antenna that is electrically connected to the IC chip and exchanges data wirelessly (in a contactless manner) with the respective apparatuses or the mobile terminal held by the operator.

The endoscope processor 10 creates an endoscopic image on the basis of a signal of an image photographed and outputted by the photographing unit that includes the CCD or the like and is built in the insertion part of the endoscope 12. Then, the endoscope processor 10 displays the created endoscopic image on an attached monitor (not illustrated) and also records the created endoscopic image.

A cleaning bath with a lid is provided on an upper surface of a box-like apparatus main body of the cleaning apparatus 30. With the endoscope 12 after use being housed in the cleaning bath, the cleaning apparatus 30 acquires the ID of the endoscope 12 to be cleaned (identification information specific to each endoscope) by means of the RFID tag 14, and performs various processes such as cleaning, disinfection, rinsing, and drying, to thereby clean and disinfect the endoscope 12.

The management server 20 holds history information on cleaning and disinfection (hereinafter, referred to as cleaning information) of the endoscope 12, communicates with the endoscope processor 10 and the cleaning apparatus 30 via the LAN, and manages the endoscopic examination and the cleaning of the endoscope 12 after the examination.

The association among the respective apparatuses such as the endoscope 12, the endoscope processor 10, and the cleaning apparatus 30 is controlled by the management server 20.

FIG. 2 is a block diagram illustrating an electrical configuration of the cleaning apparatus 30. As illustrated in FIG. 2, the cleaning apparatus 30 includes: a CPU (central processing unit) 32 that comprehensively controls the entire apparatus; a ROM (read-only memory) 34 that stores therein a control program and various pieces of data; a RAM (random access memory) 36 that is an execution region of the control program read out from the ROM 34; an RFID reader 40 that communicates with the RFID tag 14 of the endoscope 12 to read the ID of the endoscope 12; and a communication unit 42 that communicates with the respective apparatuses (the management server 20 and the like) via the LAN. In addition, an operation panel 44, an LCD (liquid crystal display) driver 48 that drives a display panel 46, a motor driver 50, a valve driver 52, a liquid level sensor 54, a temperature sensor 56, a cleaning evaluation device 58, a disinfection evaluation device 60, and other members are connected to the CPU 32.

The motor driver 50 drives a motor of a pump that supplies water, a cleaning agent, or a disinfectant solution to the cleaning bath. The valve driver 52 controls solenoid valves that are driven when the water, the cleaning agent, the disinfectant solution, or the like is supplied to the cleaning bath and when the used disinfectant solution flowing into a waste solution port is returned to the disinfectant solution tank. The liquid level sensor 54 detects the liquid level of a liquid reserved in the cleaning bath. The temperature sensor 56 detects the temperature of the liquid reserved in the cleaning bath.

The cleaning evaluation device 58 detects the degree of contamination of the endoscope 12 after the cleaning, and determines on the basis of the detection result whether or not re-cleaning of the endoscope 12 is necessary.

The disinfection evaluation device 60 detects the degree of remaining bacteria attached to the endoscope 12 after the disinfection, and determines on the basis of the detection result whether or not re-disinfection of the endoscope 12 is necessary.

Each time the cleaning apparatus 30 performs cleaning of the endoscope 12, the cleaning apparatus 30 generates cleaning information on the cleaning and transmits the cleaning information to the management server 20. The management server 20 stores therein, for example, the cleaning information for each ID of the endoscope 12. The cleaning information includes the ID of the endoscope 12, an ID of the cleaning apparatus 30, a cleaning date of the endoscope 12, a start time of cleaning (cleaning start time), an end time of cleaning (cleaning end time), a name of a person in charge of cleaning, a cleaning duration time, a disinfection duration time, a cleaning agent name, a disinfectant solution name, a disinfectant solution temperature, the number of times of cleaning, the number of times of disinfection, the total number of times of cleaning, the total number of times of disinfection, a used cleaning program, and other items.

The ID of the cleaning apparatus 30 is, for example, identification information individually assigned to the cleaning apparatus 30 similarly to the ID of the endoscope 12. The person in charge of cleaning is a staff who places the endoscope 12 in the cleaning apparatus 30 and gives an instruction to start the cleaning and disinfection. The name of the person in charge of cleaning is inputted from, for example, the operation panel 44. The cleaning apparatus 30 may be provided with a card reader, and the name of the person in charge of cleaning and his/her ID number may be read from an ID card. The duration times and the start and end times are acquired from a system timer of the CPU 32. The cleaning agent name and the disinfectant solution name are acquired by reading out preset information. The disinfectant solution temperature is acquired from the temperature sensor 56 that is provided to the cleaning bath and detects the temperature of the disinfectant solution supplied into the cleaning bath.

The number of times of cleaning is the number of times of the cleaning process that is repeatedly performed until cleaning evaluation to be described later is passed. Similarly, the number of times of disinfection is the number of times of the disinfection process that is repeatedly performed until disinfection evaluation to be described later is passed.

The total number of times of cleaning is the sum of the number of times of the cleaning process that has ever been performed on the endoscope 12. Similarly, the total number of times of disinfection is the sum of the number of times of the disinfection process that has ever been performed on the endoscope 12.

The above-mentioned items of the cleaning information are given merely as an example, and the cleaning information does not necessarily need to include all the items. In addition, items other than the above-mentioned items, for example, a model number and a serial number of the endoscope 12 may be added to the cleaning information. Other items to be added are selected as appropriate depending on the level required by a user.

The prepared cleaning program includes, for example, three types of A, B, and C, and is stored in the ROM 34 in advance. The cleaning program A is a program for performing both of the cleaning step and the disinfection step. The cleaning program B is a program for performing only the cleaning step with the disinfection step being omitted. The cleaning program C is a program for performing only the disinfection step with the cleaning step being omitted.

Next, operations of the present embodiment are described.

### First Operation Example

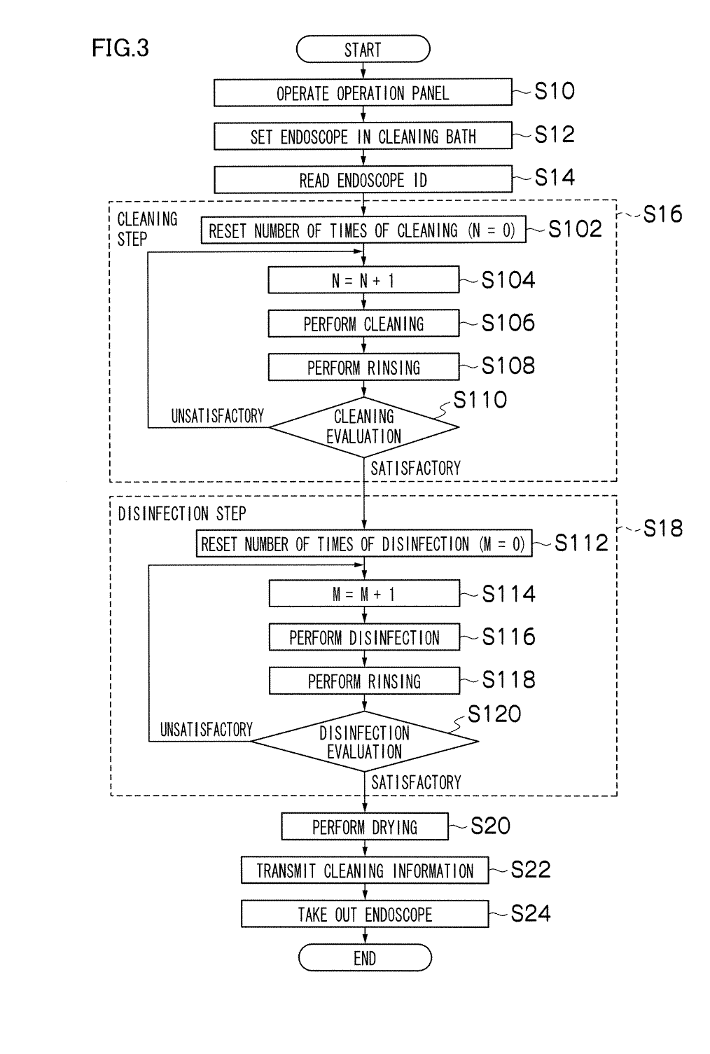

FIG. 3 is a flow chart illustrating a first operation example of the cleaning apparatus 30. Hereinafter, the first operation example of the cleaning apparatus 30 is described with reference to FIG. 3.

The endoscope 12 is washed with water (preliminary cleaning) in a sink immediately after the end of examination, and waste substances and other substances attached thereto are washed away before drying to become difficult to remove. In order to enable cleaning of the endoscope 12 to be started immediately after the preliminary cleaning, it is preferable to turn on the cleaning apparatus 30 in advance. When the cleaning apparatus 30 is turned on, the operation panel 44 lights up, and inputs of various commands are enabled.

The operator (person in charge of cleaning) operates the operation panel 44 to select, for example, the cleaning program A from among the cleaning programs A, B, and C defining the contents of the cleaning process, and inputs an instruction to execute the selected cleaning program (Step S10). The CPU 32 loads the selected cleaning program from the ROM 34 to the RAM 36 on the basis of the inputted instruction, and stands by for the execution.

Next, the endoscope 12 after being used for the endoscopic examination is housed and set in the cleaning bath of the cleaning apparatus 30 (Step S14). Then, in order to clean the inside of an endoscope conduit, a port that is provided in the cleaning bath and serves to supply a fluid such as liquid and gas into the endoscope conduit and a conduit connection port opened on an outer surface of the endoscope 12 are connected to each other via a tube or other member.

Next, the ID of the endoscope 12 housed in the cleaning bath is read by the RFID reader 40 of the cleaning apparatus 30 (Step S14). The ID of the endoscope 12 read by the RFID reader 40 is stored into an EEPROM (electrically erasable programmable read-only memory) 38.

Next, the cleaning bath is covered with the lid, and the cleaning step is started upon turning-on of a process start switch (Step S16). In the cleaning step, first, a number of times N of cleaning is reset to 0 (Step S102). Subsequently, the number of times N of cleaning is incremented (that is, N=N+1) (Step S104). Then, the cleaning process to be described later is performed (Step S106).

In the cleaning process, first, tap water is supplied from a water supply nozzle into the cleaning bath, and the cleaning agent in a cleaning agent tank is supplied from a cleaning agent supply nozzle into the cleaning bath, whereby a cleaning solution formed by mixing the water and the cleaning agent is supplied into the cleaning bath. After the cleaning solution reaches a predetermined water level, the cleaning is started. The cleaning solution is circulating, and the outer surface of the endoscope 12 is cleaned by a stream of the circulation.

In addition, at this time, part of the cleaning solution in the cleaning bath is sucked by a circulation pump to be introduced into each endoscope conduit via the tube and the conduit connection port, and the inside of the endoscope conduit is thus cleaned by a water pressure of the introduced cleaning solution.

Upon the end of the cleaning process, the supply of the cleaning agent from the cleaning agent supply nozzle is stopped, and the rinsing process is started by supplying water from the water supply nozzle into the cleaning bath (Step S108). In this process, the water is circulated in the cleaning bath and the endoscope conduit in the same manner as that of the cleaning solution, and the outer surface of the endoscope 12 and the inside of the endoscope conduit are rinsed. Then, the cleaning solution remaining on the outer surface of the endoscope 12 and in the endoscope conduit is removed.

Upon the end of the rinsing process, the cleaning evaluation for the endoscope 12 is performed (Step S110). Examples of the method for the cleaning evaluation include an adenosine triphosphate (ATP) measurement method, a color dyeing method, a culture method, an occult blood reaction method, a hydrogen peroxide reaction method, and a ninhydrin method, and the ATP measurement method is preferably used among these methods.

According to the NIP measurement method, the endoscope 12 to be examined is wiped with a wiping member (for example, a cotton swab) in a direct-contact manner, and a luminescent reagent is added to the wiping member, to thereby cause ATP to emit light. Then, the amount of ATP, that is, the degree of contamination of the endoscope 12 can be detected by measuring the amount of light emitted from the ATP. This makes it possible to promptly and accurately determine whether or not the cleaning level of the endoscope 12 satisfies a predetermined criterion.

Instead of performing such wiping examination of the endoscope 12 as described above, part of the water used in the rinsing process (that is, a rinsing solution) is sampled, and the amount of ATP is measured in the same manner as that of the wiping member, whereby the degree of contamination of the endoscope 12 can be detected.

The degree of contamination of the endoscope 12 thus detected may be determined by absolute evaluation using a value of the amount of emitted light (that is, the amount of ATP) or may be determined by relative evaluation to a predetermined criterion value or a measurement value.

The cleaning evaluation device 58 illustrated in FIG. 2 performs the cleaning evaluation using the ATP measurement method as described above. Specifically, in response to the control of the CPU 32, the cleaning evaluation device 58 performs wiping with the wiping member, addition of various reagents, measurement of the amount of light emitted from the ATP, and other processes.

Note that, the cleaning apparatus 30 does not necessarily need to include the cleaning evaluation device 58, and the operator may perform the cleaning evaluation for the endoscope 12 off-line. For example, in the case of performing the cleaning evaluation for the endoscope 12 off-line, the operator performs wiping with the wiping member and addition of various reagents, and measures the amount of light emitted from the ATP using a predetermined measuring apparatus. Then, the cleaning evaluation for the endoscope 12 is determined on the basis of the measured amount of emitted light.

As a result of the cleaning evaluation, if the cleaning level of the endoscope 12 does not satisfy the predetermined criterion (UNSATISFACTORY in Step S110), processing from Step S104 to Step S110 is repeated until the cleaning level of the endoscope 12 satisfies the predetermined criterion.

On the other hand, if the cleaning level of the endoscope 12 satisfies the predetermined criterion (SATISFACTORY in Step S110), the disinfection step to be described later is started (Step S18).

In the disinfection step, first, a number of times M of disinfection is reset to 0 (Step S112). Subsequently, the number of times M of disinfection is incremented (that is, M=M+1) (Step S114). Then, the disinfectant solution is supplied from a disinfectant solution supply nozzle into the cleaning bath, and the disinfectant solution is circulated in the cleaning bath and the endoscope conduit in the same manner as that of the cleaning solution, whereby the outer surface of the endoscope 12 and the inside of the endoscope conduit are disinfected. Peracetic acid, hydrogen peroxide solution, glutaral, phtharal, electrolyzed acid water, and ozone water can be used as the disinfectant solution.

Upon the end of the disinfection step, the rinsing process (Step S118) similar to the rinsing process (Step S108) in the cleaning step is performed, and the disinfectant solution remaining on the outer surface of the endoscope 12 and in the endoscope conduit is removed.

Next, the disinfection evaluation for the endoscope 12 after the disinfection is performed (Step S120). The method for the disinfection evaluation is not particularly limited, and a fluorescence staining and filtering method is preferably used. The fluorescence staining and filtering method is a method that enables culture-independent detection of living bacteria, that is, a method that does not require a culture step, and the number of living bacteria can be promptly measured according to this method. This makes it possible to promptly and accurately determine whether or not the disinfection level of the endoscope 12 satisfies a predetermined criterion.

As a result of the disinfection evaluation, if the disinfection level of the endoscope 12 does not satisfy the predetermined criterion (UNSATISFACTORY in Step S120), processing from Step S114 to Step S120 is repeatedly performed until the disinfection level satisfies the predetermined criterion.

On the other hand, if the disinfection level of the endoscope 12 satisfies the predetermined criterion (SATISFACTORY in Step S120), the drying step is performed (Step S20). In this step, air or alcohol is supplied to the outer surface of the endoscope 12 and the endoscope conduit similarly to the supplies of the cleaning solution and the disinfectant solution, whereby drying of the outer surface of the endoscope 12 and the inside of the endoscope conduit is accelerated.

Upon the end of the drying step, a message to the effect that all the steps of the selected cleaning program are completed is displayed on the display panel 46, and the cleaning information (the ID of the endoscope 12, the number of times of cleaning, the number of times of disinfection, the cleaning end time, and other items) of this time is transmitted to the management server 20 (Step S22). The management server 20 updates the cleaning information corresponding to the ID of the endoscope 12. That is, if the cleaning and disinfection of the endoscope 12 is performed, the cleaning information managed by the management server 20 is updated.

After that, the lid of the cleaning bath is opened, and the endoscope 12 is taken out of the cleaning bath (Step S24).

In this way, according to the first operation example, the cleaning process is repetitively performed until the cleaning evaluation is passed in the cleaning step of the endoscope 12. Accordingly, even in the case where the cleaning of the endoscope 12 is insufficient, contamination attached to the endoscope can be removed by re-cleaning, while excessive cleaning of the endoscope 12 is prevented. This makes it possible to reliably secure the cleaning level of the endoscope 12, and a sufficient effect can be obtained in the subsequent disinfection.

In addition, the disinfection process is repetitively performed until the disinfection evaluation is passed in the disinfection step of the endoscope 12.

Accordingly, it is possible to prevent the endoscope 12 that has not been sufficiently disinfected from being used, and the safety and reliability of the endoscope 12 can be secured.

### Second Operation Example

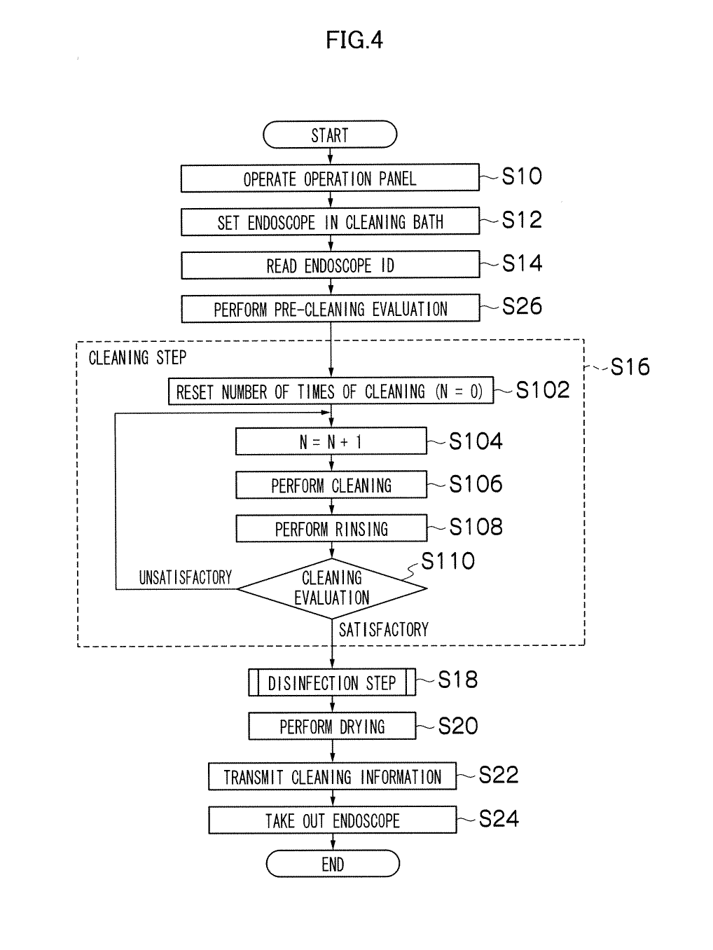

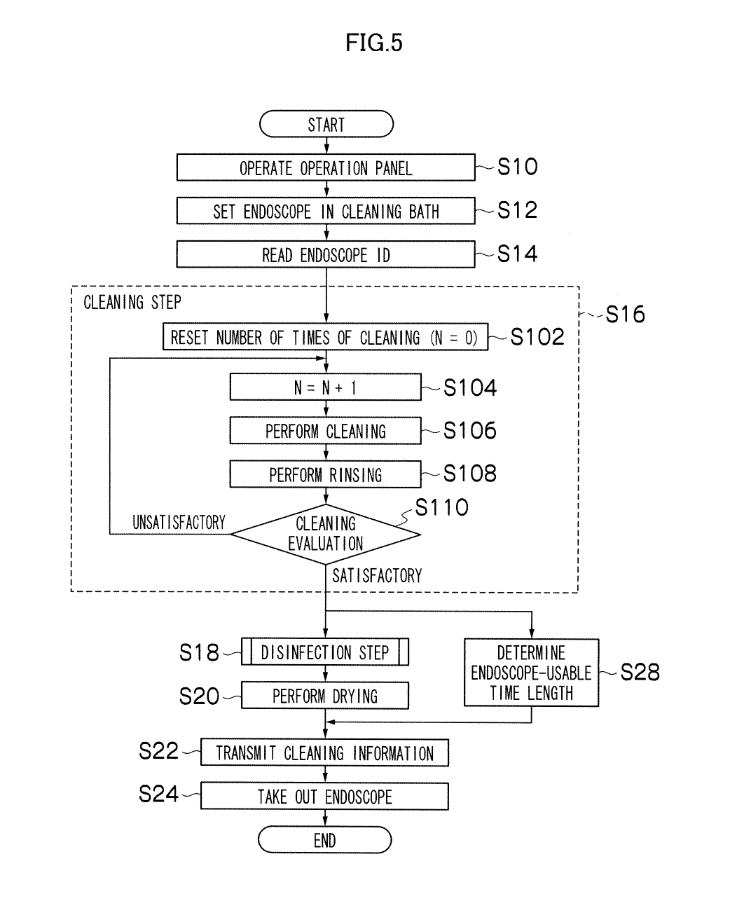

FIG. 4 is a flow chart illustrating a second operation example of the cleaning apparatus 30. In FIG. 4, processes common to those of FIG. 3 are designated by the same reference characters and numerals, and description thereof will be omitted.

In the second operation example, before the cleaning step (Step S16) of the endoscope 12 is performed, pre-cleaning evaluation is performed (Step S26). The pre-cleaning evaluation is performed in the same manner as that of the cleaning evaluation in Step S110. Accordingly, at the time of the cleaning evaluation in Step S110, a cleaning effect on the endoscope 12 can be checked by performing relative evaluation to the degree of contamination of the endoscope 12 detected by the pre-cleaning evaluation.

In addition, in the second operation example, the degree of contamination of the endoscope 12 detected by the pre-cleaning evaluation may be displayed on a display device such as the display panel 46. For the display method therefor, an index value (for example, the amount of ATP or the amount of emitted light) indicating the degree of contamination may be numerically displayed, and alternatively, the degree of contamination may be displayed in a stepwise manner at a plurality of levels. This enables the operator to easily understand whether or not the preliminary cleaning performed immediately after the endoscopic examination is appropriately performed, and the preliminary cleaning can be made proper. As a result, the cleaning efficiency of the cleaning apparatus 30 can be enhanced, and the cleanliness of the endoscope 12 can be further increased.

### Third Operation Example

FIG. 5 is a flow chart illustrating a third operation example of the cleaning apparatus 30. In FIG. 5, processes common to those of FIG. 3 are designated by the same reference characters and numerals, and description thereof will be omitted.

In the third operation example, as illustrated in FIG. 5, after the cleaning evaluation in Step S110 is passed, a usable time length of the endoscope 12 is determined in accordance with the number of times N of cleaning (Step S28). The usable time length of the endoscope 12 refers to a length of time (re-cleaning-unnecessary time length) for which the endoscope 12 that has been cleaned can be safely used. Therefore, the endoscope 12 after an elapse of the endoscope-usable time length since the cleaning is performed thereon needs to be re-cleaned.

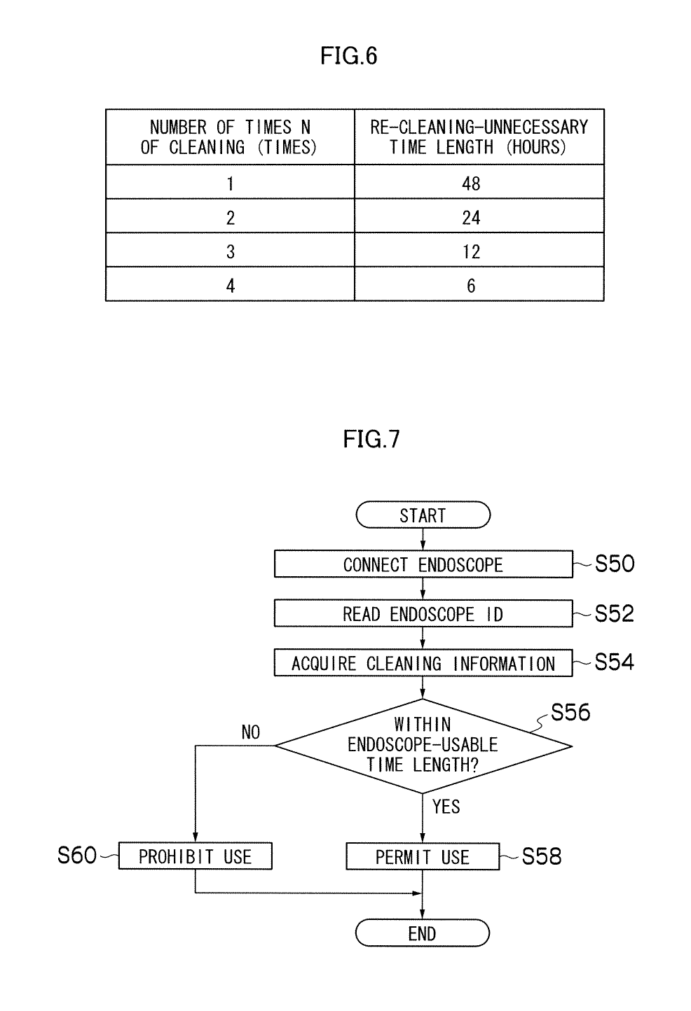

Here, an example of a correspondence relation between the number of times N of cleaning and the endoscope-usable time length is illustrated in FIG. 6. In the example illustrated in FIG. 6, when the number of times N of cleaning is 1, 2, 3, and 4, the endoscope-usable time length is set to 48, 24, 12, and 6 hours, respectively. In the case where the number of times N of cleaning until the cleaning evaluation is passed is large, the endoscope 12 is determined to have contamination difficult to remove therefrom. Accordingly, as the number of times N of cleaning is larger, the endoscope-usable time length is set to be shorter, and the cleaning is performed at a shorter interval.

The correspondence relation between the number of times N of cleaning and the endoscope-usable time length is stored in the EEPROM 38 as a data table. The CPU 32 refers to the data table stored in the EEPROM 38 to thereby determine the usable time length of the endoscope 12 on the basis of the number of times N of cleaning. The determined endoscope-usable time length is stored into the EEPROM 38 and is transmitted to the management server 20 as part of the cleaning information (Step S22).

Note that, the data table may be stored in the management server 20, and the management server 20 may determine the usable time length of the endoscope 12 on the basis of the number of times N of cleaning acquired from the cleaning apparatus 30.

Here, a flow chart of an operation example of the endoscope processor 10 is illustrated in FIG. 7. As illustrated in FIG. 7, first, the endoscope 12 is connected to the endoscope processor 10 (Step S50). Subsequently, the ID of the endoscope 12 is read by the RFID reader (not illustrated) of the endoscope processor 10 (Step S52).

Next, the ID of the endoscope 12 is transmitted to the management server 20, and the cleaning information corresponding to the ID of the endoscope 12 is acquired from the management server 20 (Step S54). At this time, the cleaning information acquired from the management server 20 includes at least the usable time length of the endoscope 12 and the cleaning end time.

Next, it is determined whether or not an elapsed time since the cleaning of the endoscope 12 (current time−cleaning end time) falls within the endoscope-usable time length (Step S56). If the elapsed time since the cleaning of the endoscope 12 does not exceed the endoscope-usable time length (Yes in Step S56), a process of permitting the use of the endoscope 12 is performed, a message to the effect that the endoscope 12 can be still used is displayed on the endoscope processor 10 or the attached monitor, and the start of the endoscopic examination is enabled (Step S58).

On the other hand, if the elapsed time since the cleaning of the endoscope 12 exceeds the endoscope-usable time length (No in Step S56), a process of prohibiting the use of the endoscope 12 is performed, a message to the effect that the endoscope 12 cannot be used is displayed on the endoscope processor 10 or the attached monitor, and the start of the endoscopic examination is disabled (Step S60). In this case, the endoscope 12 is detached from the endoscope processor 10, is carried to the cleaning room, and is cleaned by the cleaning apparatus 30.

According to the third operation example, the usable time length of the endoscope 12 is set in accordance with the number of times N of cleaning until the cleaning evaluation is passed. And if the elapsed time since the cleaning of the endoscope 12 exceeds the endoscope-usable time length, the use of the endoscope 12 is prohibited, and the start of the endoscopic examination is disabled. Accordingly, it is possible to reliably prevent the endoscope 12 from being used beyond the endoscope-usable time length, and the safety and reliability of the endoscope 12 can be enhanced.

### Fourth Operation Example

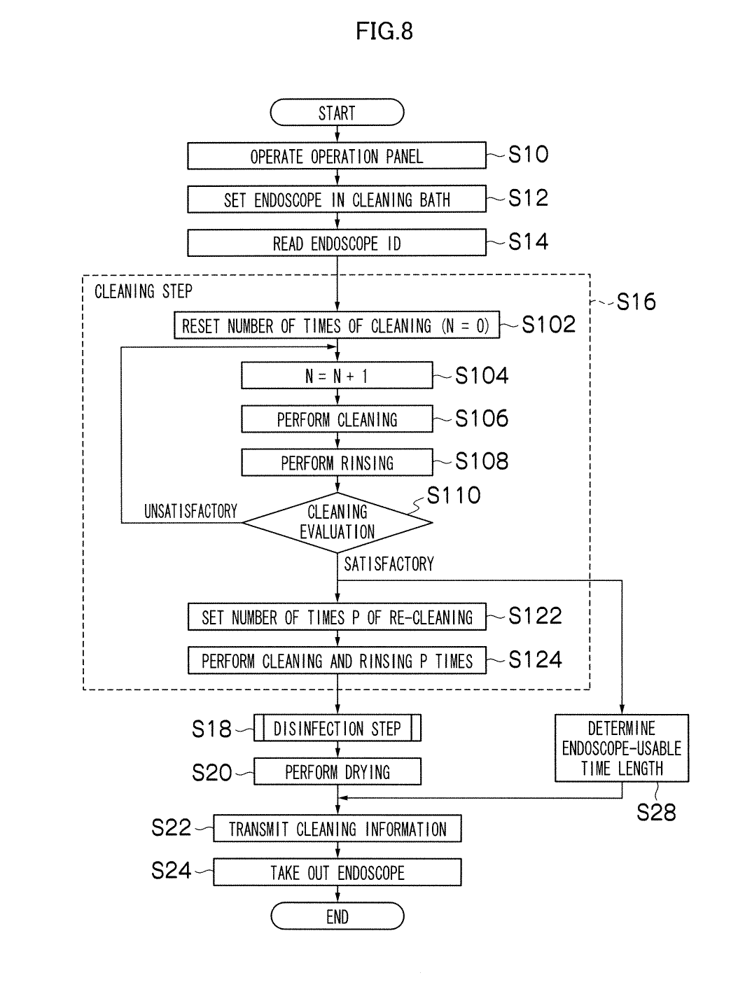

FIG. 8 is a flow chart illustrating a fourth operation example of the cleaning apparatus 30. In FIG. 8, processes common to those of FIG. 3 or FIG. 5 are designated by the same reference characters and numerals, and description thereof will be omitted.

In the fourth operation example, as illustrated in FIG. 8, after the cleaning evaluation in Step S110 is passed, a number of times P of re-cleaning is set in accordance with the number of times N of cleaning (Step S122). Then, the cleaning process and the rinsing process are repeatedly performed P times in the same manner as in Step S106 and Step S108 (Step S124).

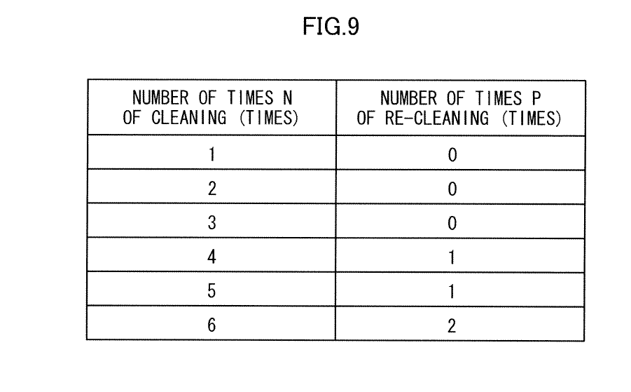

Here, an example of a correspondence relation between the number of times N of cleaning and the number of times P of re-cleaning is illustrated in FIG. 9. In the example illustrated in FIG. 9, the number of times P of re-cleaning when the number of times N of cleaning is equal to or less than 3 is 0. In contrast to this, the number of times P of re-cleaning when the number of times N of cleaning is equal to or more than 4 is equal to or more than 1. Specifically, as the number of times N of cleaning is larger, the number of times P of re-cleaning is also larger. The endoscope 12 with a large number of times N of cleaning until the cleaning evaluation is passed is determined to have a structure or a material from which contamination is difficult to remove by cleaning. Accordingly, even if the cleaning evaluation is passed, the endoscope 12 with a large number of times N of cleaning is re-cleaned a predetermined number of times in terms of preventive maintenance.

In this way, according to the fourth operation example, even if the cleaning evaluation is passed, the endoscope 12 with a large number of times N of cleaning is additionally re-cleaned. This makes it possible to reliably secure the cleanliness of the endoscope 12.

### Fifth Operation Example

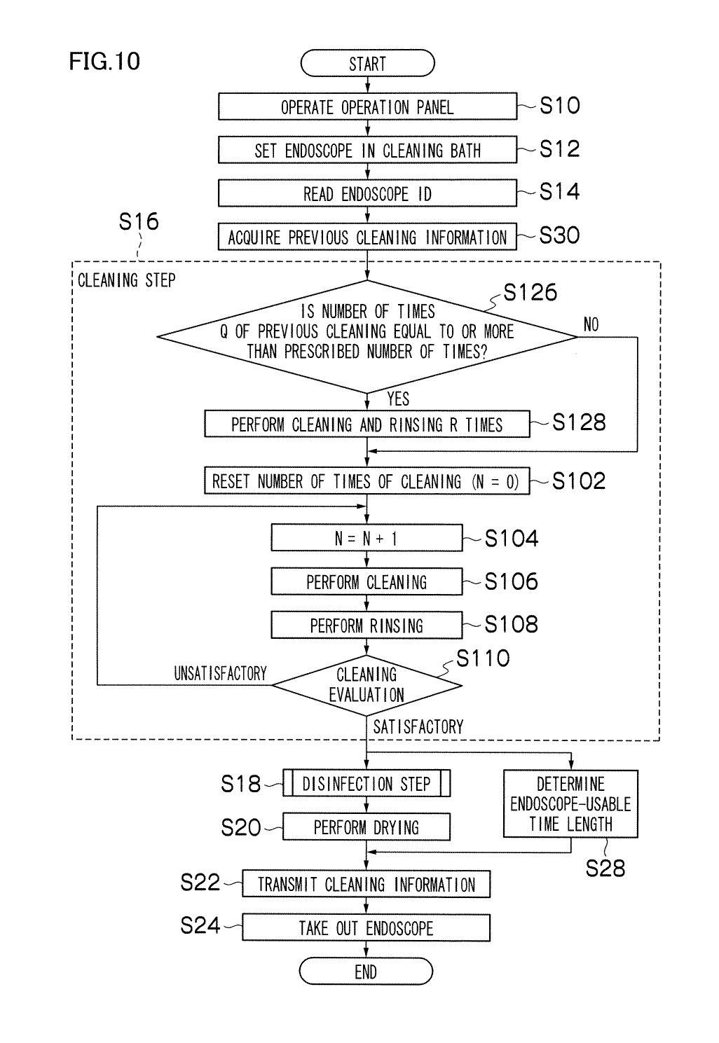

FIG. 10 is a flow chart illustrating a fifth operation example of the cleaning apparatus 30. In FIG. 10, processes common to those of FIG. 3 or FIG. 5 are designated by the same reference characters and numerals, and description thereof will be omitted.

In the fifth operation example, as illustrated in FIG. 10, after the ID of the endoscope 12 is read in Step S14, the ID of the endoscope 12 is transmitted to the management server 20, and the cleaning information corresponding to the ID of the endoscope 12 is acquired from the management server 20 (Step S30). The cleaning information acquired in Step S30 includes a number of times Q of previous cleaning when the endoscope 12 is cleaned last time.

In addition, it is preferable that the cleaning information acquired from the management server 20 include the total number of times of cleaning indicating the sum of the number of times the cleaning process of the endoscope 12 has ever been performed. If the total number of times of cleaning is equal to or more than a predetermined number of times, a message to the effect that the maintenance of the endoscope 12 is necessary is displayed on the display panel 46. Displaying the above message enables the operator to understand that the maintenance timing of the endoscope 12 has come. Alternatively, not limited to the total number of times of cleaning, such a message may be displayed in accordance with the number of times Q of previous cleaning.

Next, it is determined whether or not the number of times Q of previous cleaning is equal to or more than a prescribed number of times (for example, 4 times) (Step S126). If the number of times Q of previous cleaning is equal to or more than the prescribed number of times (Yes in Step S126), the cleaning process and the rinsing process are repeatedly performed R times (for example, Q—2 times) in the same manner as in Step S106 and Step S108 (Step S128).

On the other hand, if the number of times Q of previous cleaning is less than the prescribed number of times (No in Step S126), first, the number of times N of cleaning is reset to 0 (Step S102). Then, the increment of the number of times N of cleaning (Step S104), the cleaning process (Step S106), and the rinsing process (Step S108) are repetitively performed until the criterion of the cleaning evaluation in Step S110 is satisfied, in the same manner as in the first operation example.

In addition, after the criterion of the cleaning evaluation in Step S110 is satisfied, the usable time length of the endoscope 12 is determined in accordance with the number of times N of cleaning in the same manner as in the third operation example (Step S28). In this step, it is preferable to determine the usable time length of the endoscope 12 in accordance with a value obtained by adding R to the number of times N of cleaning.

According to the fifth operation example, with regard to the endoscope 12 with the number of times Q of previous cleaning being equal to or more than the prescribed number of times, the cleaning process and the rinsing process are performed thereon a predetermined number of times without performing the cleaning evaluation, and after that, the cleaning process and the rinsing process are repetitively performed thereon until the criterion of the cleaning evaluation is satisfied, in the same manner as that of the endoscope 12 with the number of times Q of previous cleaning being less than the prescribed number of times. In this way, the cleaning evaluation is partially omitted in accordance with the number of times Q of previous cleaning, whereby the time required for the cleaning evaluation for the endoscope 12 can be reduced, leading to improved efficiency in entire processing.

### Sixth Operation Example

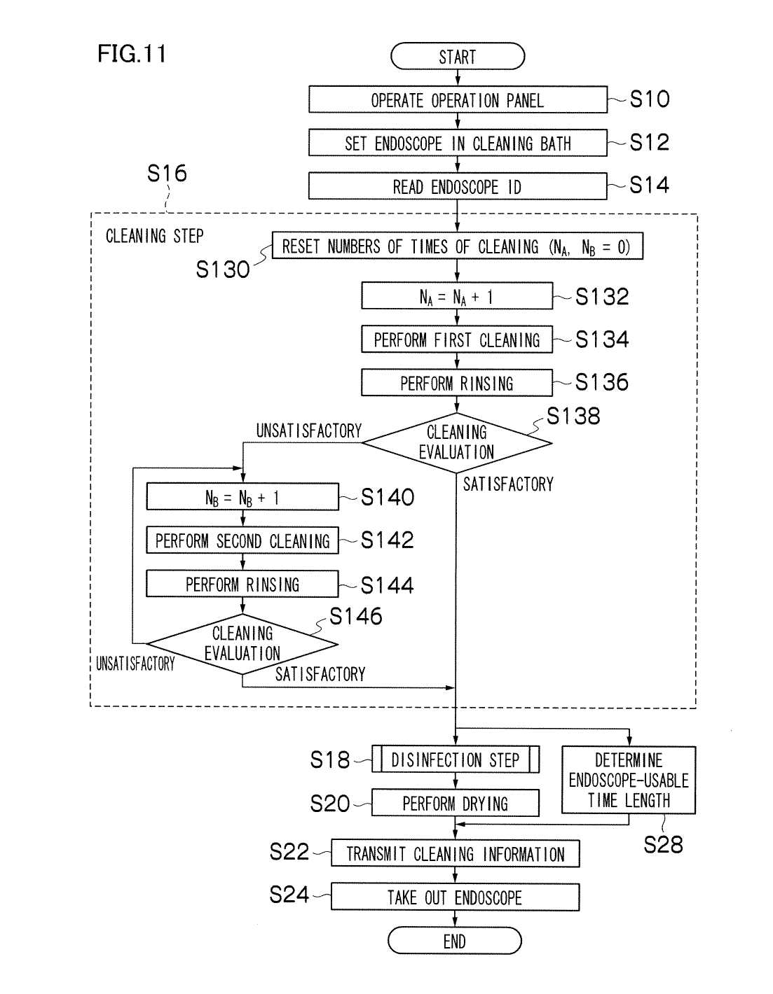

FIG. 11 is a flow chart illustrating a sixth operation example of the cleaning apparatus 30. In FIG. 11, processes common to those of FIG. 3 or FIG. 5 are designated by the same reference characters and numerals, and description thereof will be omitted.

In the sixth operation example, as illustrated in FIG. 11, after the ID of the endoscope 12 is read (Step S14), numbers of times N_{A} and N_{B} of cleaning are each reset to 0 (Step S130). The numbers of times N_{A} and N_{B} of cleaning are variables for respectively counting the numbers of times first and second cleaning processes to be described later are performed. Note that, the cleaning apparatus 30 can selectively supply, for example, two types of cleaning agents A and B, and can perform two types of cleaning processes (first and second cleaning processes) using different cleaning methods.

Next, the number of times N_{A} of cleaning is incremented (Step S132), and the first cleaning process is performed (Step S134). In the first cleaning process, the cleaning agent A having a cleaning effect necessary to remove normal contamination attached to the endoscope 12 is used, and the endoscope 12 is not damaged as long as the cleaning duration time using the cleaning agent A falls within a normal range.

Upon the end of the first cleaning process for a predetermined time, the rinsing process is performed in the same manner as in the rinsing process (Step S108) of the first operation example (Step S136).

Next, the cleaning evaluation for the endoscope 12 is performed (Step S138). Similarly to the first operation example, the ATP measurement method is preferably used as the method for the cleaning evaluation. As a result of the cleaning evaluation, if the cleaning level satisfies a predetermined criterion (SATISFACTORY in Step S138), the disinfection step in Step S18 is started. On the other hand, if the cleaning level does not satisfy the predetermined criterion (UNSATISFACTORY in Step S138), the following processing is performed.

First, the number of times N_{B} of cleaning is incremented (Step S140), and subsequently, the second cleaning process is performed (Step S142). In the second cleaning process, the cleaning agent B having a cleaning effect necessary to remove persistent contamination (contamination which is difficult to be cleaned by the cleaning agent A, but can be cleaned by the cleaning agent B) attached to the endoscope 12 is used. The cleaning agent B has a cleaning mechanism (that is, main active components) different from that of the cleaning agent A used in the first cleaning process. The cleaning agent B has a higher cleaning effect than that of the cleaning agent A, but excessive use of the cleaning agent B may damage the endoscope 12. In addition, the cleaning agent B having such an effect as described above is generally more expensive than the cleaning agent A, and hence excessive use of the cleaning agent B causes an increase in running cost of the cleaning apparatus 30. Therefore, the cleaning agent B has a higher cleaning effect than that of the cleaning agent A, but also has harmful effects, and hence it is preferable to suppress the use of the cleaning agent B to the minimum.

Examples of the combination of the cleaning agent A and the cleaning agent B include: an alkaline cleaning agent and an enzymatic cleaning agent; and a mild-alkaline cleaning agent and a strong-alkaline cleaning agent.

Upon the end of the second cleaning process, the rinsing process is performed in the same manner as in the rinsing process (Step S108) of the first operation example (Step S144).

Next, the cleaning evaluation for the endoscope 12 is performed (Step S146). Similarly to the first operation example, the ATP measurement method is preferably used as the method for the cleaning evaluation. As a result of the cleaning evaluation, if the cleaning level satisfies a predetermined criterion (SATISFACTORY in Step S146), the disinfection step in Step S18 is started. On the other hand, if the cleaning level does not satisfy the predetermined criterion (UNSATISFACTORY in Step S146), processing from Step S132 to Step S146 is repeatedly performed until the cleaning evaluation in Step S138 or Step S146 is passed.

In this way, according to the sixth operation example, the cleaning evaluation is performed for determining whether or not the cleaning level of the endoscope 12 after the cleaning satisfies the predetermined criterion. If the cleaning level does not satisfy the predetermined criterion, the endoscope 12 is re-cleaned according to a different method (in this example, a method of changing the type of a cleaning agent). Accordingly, even in the case where the cleaning of the endoscope 12 is insufficient, contamination attached to the endoscope can be reliably removed, while excessive cleaning of the endoscope 12 is prevented. This makes it possible to reliably secure the cleaning level of the endoscope 12, and a sufficient effect can be obtained in the subsequent disinfection.

In addition, since the cleaning is performed using the different two types of cleaning agents, the service life of the endoscope 12 can be prolonged with damage of the endoscope 12 due to the cleaning being suppressed. Further, the cost of the cleaning solution can be reduced.

In the sixth operation example, as described above, the type of the used cleaning agent is different between the first and second cleaning processes. The presently disclosed subject matter is not limited to this example, and the concentration of the used cleaning solution (cleaning agent concentration) or the temperature of the used cleaning solution may be different between the first and second cleaning processes.

In the mode of changing the concentration of the cleaning solution, in the first cleaning process, the endoscope 12 is cleaned using a low-concentration cleaning solution to which a predetermined amount of cleaning agent is added, whereas in the second cleaning process, the endoscope 12 is cleaned using a high-concentration cleaning solution to which a larger amount of cleaning agent than that in the first cleaning process is added.

In the mode of changing the temperature of the cleaning solution, in the first cleaning process, the endoscope 12 is cleaned using a room-temperature cleaning solution, whereas in the second cleaning process, the endoscope 12 is cleaned using a cleaning solution having a temperature (for example, 40° C.) higher than that in the first cleaning process (the room temperature).

According to still another mode, a duration time for which the endoscope 12 is immersed in the cleaning solution (that is, cleaning duration time) may be different for each cleaning process. That is, in the first cleaning process, the endoscope 12 is immersed in the cleaning solution for a predetermined time, whereas in the second cleaning process, the endoscope 12 is immersed therein for a time longer than that in the first cleaning process (the predetermined time).

In any modes, similarly to the mode of using the different two types of cleaning agents, contamination attached to the endoscope 12 can be reliably removed with damage of the endoscope 12 due to the cleaning being suppressed, and the cost of the cleaning solution can be reduced.

### Seventh Operation Example

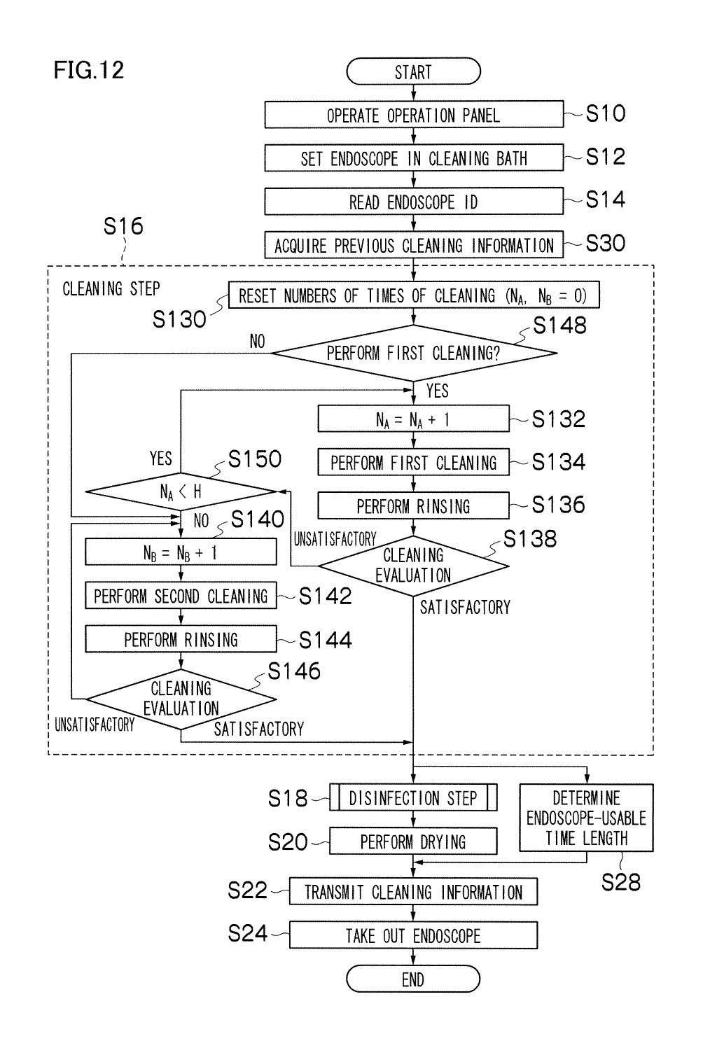

FIG. 12 is a flow chart illustrating a seventh operation example of the cleaning apparatus 30. In FIG. 12, processes common to those of FIG. 3, FIG. 5, or FIG. 11 are designated by the same reference characters and numerals, and description thereof will be omitted.

In the seventh operation example, the first and second cleaning processes using the different cleaning methods are performed similarly to the sixth operation example. The seventh operation example is different from the sixth operation example in that whether or not the first and second cleaning processes are to be performed is determined on the basis of the previous cleaning information.

Specifically, as illustrated in FIG. 12, after the ID of the endoscope 12 is read in Step S14, the ID of the endoscope 12 is transmitted to the management server 20, and the cleaning information corresponding to the ID of the endoscope 12 is acquired from the management server 20 (Step S30). The cleaning information acquired in this step includes numbers of times Q_{A} and Q_{B} the respective first and second cleaning processes are performed during the previous cleaning.

In addition, it is preferable that the cleaning information acquired from the management server 20 include the first and second total numbers of times of cleaning respectively indicating the sums of the numbers of times the first and second cleaning processes have ever been performed. For example, if the second total number of times of cleaning that remarkably affects a damage state of the endoscope 12 is equal to or more than a predetermined number of times, a message to the effect that the maintenance of the endoscope 12 is necessary is displayed on the display panel 46, and this enables the operator to understand that the maintenance timing of the endoscope 12 has come. In addition, not limited to the second total number of times of cleaning, the first total number of times of cleaning or the sum of the first and second total numbers of times of cleaning may be used as the criterion. Alternatively, such a message may be displayed in accordance with the numbers of times Q_{A} and Q_{B} of previous cleaning.

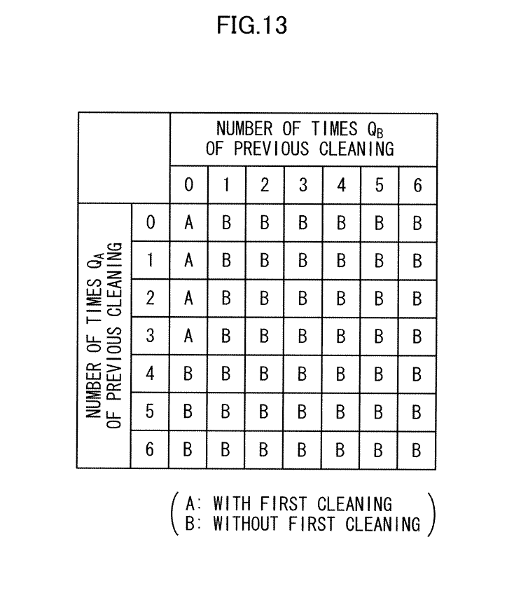

In the cleaning step, first, the numbers of times N_{A} and N_{B} of cleaning are each reset to 0 (Step S130). Subsequently, whether or not the first cleaning process is to be performed is determined in accordance with the numbers of times Q_{A} and Q_{B} of previous cleaning (Step S148). Here, an example of a determination table for determining whether or not the first cleaning process is to be performed, in accordance with the numbers of times Q_{A} and Q_{B} of previous cleaning is illustrated in FIG. 13. In the example illustrated in FIG. 13, in the case where the number of times Q_{A} of previous cleaning is equal to or less than 3 and the number of times Q_{B} of previous cleaning is 0, it is determined that the first cleaning process is to be performed. In other cases, it is determined that the first cleaning process is not to be performed (that is, the second cleaning process is performed).

If it is determined that the first cleaning process is to be performed (Yes in Step S148), the increment of the number of times N_{A} of cleaning (Step S132), the first cleaning process (Step S134), the rinsing process (Step S136), and the cleaning evaluation (Step S138) are sequentially performed in the same manner as in the sixth operation example. As a result of the cleaning evaluation, if the cleaning level satisfies the predetermined criterion (SATISFACTORY in Step S138), the disinfection step is started (Step S18).

On the other hand, if the cleaning level does not satisfy the predetermined criterion (UNSATISFACTORY in Step S138), it is determined whether or not the number of times N_{A} the first cleaning process is performed is less than a predetermined upper limit value H (for example, H=5) (Step S150). If it is determined that the number of times N_{A} of cleaning is less than the upper limit value H (Yes in Step S150), processing from Step S132 to Step S138 is repeatedly performed.

If it is determined in Step S150 that the number of times N_{A} of cleaning reaches the upper limit value H (No in Step S150) or it is determined in Step S148 that the first cleaning process is not to be performed (No in Step S148), the increment of the number of times N_{B} of cleaning (Step S140), the second cleaning process (Step S142), the rinsing process (Step S144), and the cleaning evaluation (Step S146) are sequentially performed. As a result of the cleaning evaluation, if the cleaning level satisfies the predetermined criterion (SATISFACTORY in Step S146), the disinfection step is started (Step S18). On the other hand, if the cleaning level does not satisfy the predetermined criterion (UNSATISFACTORY in Step S146), processing from Step S140 to Step S146 is repeatedly performed until the cleaning evaluation in Step S146 is passed.

According to the seventh operation example, the cleaning process adopted for cleaning the endoscope 12 is selected from among the two types of cleaning processes (first and second cleaning processes) using the different cleaning methods, in accordance with the numbers of times Q_{A} and Q_{B} of previous cleaning. In this way, the cleaning process is selected on the basis of the numbers of times Q_{A} and Q_{B} of previous cleaning, whereby the endoscope 12 can be cleaned adopting the cleaning process suited to the state of the endoscope (the degree of difficulty in removing contamination). In addition, after the cleaning is performed adopting the respective cleaning processes, the cleaning evaluation is performed for determining whether or not the cleaning level of the endoscope 12 satisfies the predetermined criterion. If the cleaning level does not satisfy the predetermined criterion, an instruction to re-clean the endoscope 12 is given. Accordingly, even in the case where the cleaning of the endoscope 12 is insufficient, contamination attached to the endoscope 12 can be reliably removed, while excessive cleaning of the endoscope 12 is prevented. This makes it possible to reliably secure the cleaning level of the endoscope 12, and a sufficient effect can be obtained in the subsequent disinfection.

For example, in the case where the endoscope 12 is determined to have contamination easy to remove by cleaning on the basis of the numbers of times Q_{A} and Q_{B} of previous cleaning, the first cleaning process, which is less damaging to the endoscope 12 and is more advantageous in terms of cost, is selected, and the second cleaning process is performed when the number of times of cleaning until the cleaning evaluation is passed reaches the predetermined number of times. Although the second cleaning process is more damaging to the endoscope 12 and is less advantageous in terms of cost than the first cleaning process, the second cleaning process has a higher cleaning effect than that of the first cleaning process and thus can more reliably remove contamination attached to the endoscope 12. On the other hand, in the case where the endoscope 12 is determined to have contamination difficult to remove by cleaning on the basis of the numbers of times Q_{A} and Q_{B} of previous cleaning, the second cleaning process is selected. In this way, the cleaning method is changed in accordance with the state of the endoscope 12 (the degree of difficulty in removing contamination), leading to shortening of the cleaning duration time for the endoscope 12 and a reduction in cost of the cleaning solution. In addition, the service life of the endoscope 12 can be prolonged with damage of the endoscope 12 due to the cleaning being suppressed.

### Eighth Operation Example

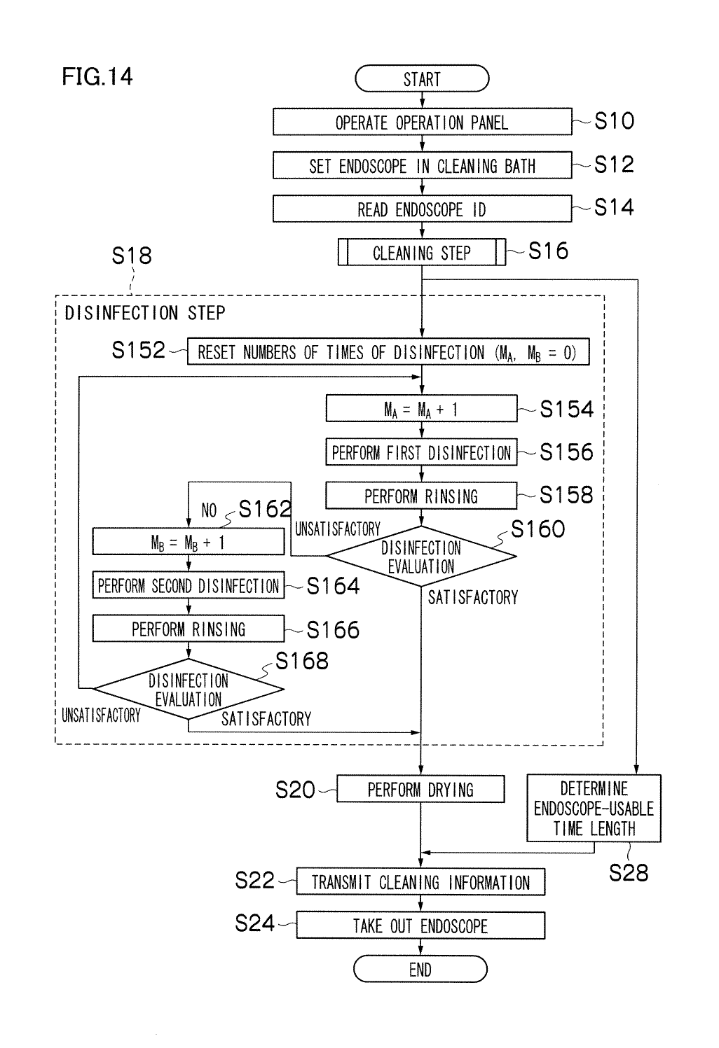

FIG. 14 is a flow chart illustrating an eighth operation example of the cleaning apparatus 30. In FIG. 14, processes common to those of FIG. 3, FIG. 5, or FIG. 11 are designated by the same reference characters and numerals, and description thereof will be omitted.

In the eighth operation example, as illustrated in FIG. 14, the cleaning step according to any one of the first to seventh operation examples is performed (Step S16), and then numbers of times M_{A} and M_{B} of disinfection are each reset to 0 (Step S152). The numbers of times M_{A} and M_{B} of disinfection are variables for respectively counting the numbers of times first and second disinfection processes to be described later are performed. Note that, the cleaning apparatus 30 can selectively supply, for example, two types of disinfectant solutions A and B, and can perform two types of disinfection processes (first and second disinfection processes) using different disinfection methods.

Next, the increment of the number of times M_{A} of disinfection (Step S154), the first disinfection process (Step S156), the rinsing process (Step S158), and the disinfection evaluation (Step S160) are sequentially performed in the same manner as in the first operation example. As a result of the disinfection evaluation, if the disinfection level satisfies a predetermined criterion (SATISFACTORY in Step S160), the drying step is started (Step S20).

On the other hand, if the disinfection level does not satisfy the predetermined criterion (UNSATISFACTORY in Step S160), the increment of the number of times M_{B} of disinfection (Step S162), the second disinfection process (Step S164), the rinsing process (Step S166), and the disinfection evaluation (Step S168) are sequentially performed. As a result of the disinfection evaluation, if the disinfection level satisfies a predetermined criterion (SATISFACTORY in Step S168), the drying step is started (Step S20). On the other hand, if the disinfection level does not satisfy the predetermined criterion (UNSATISFACTORY in Step S168), processing from Step S154 to Step S168 is repeatedly performed until the disinfection evaluation in Step S160 or Step S168 is passed.

Here, the disinfectant solution A used in the first disinfection process has a lower disinfection effect than that of the disinfectant solution B used in the second disinfection process, and is less expensive. For example, glutaral is used as the disinfectant solution A, and peracetic acid is used as the disinfectant solution B.

In this way, according to the eighth operation example, the disinfection evaluation is performed for determining whether or not the disinfection level of the endoscope 12 after the disinfection satisfies the predetermined criterion. If the disinfection level does not satisfy the predetermined criterion, the endoscope 12 is re-disinfected according to a different method (in this example, a method of changing the type of a disinfectant solution). Accordingly, even in the case where the disinfection of the endoscope 12 is insufficient, bacteria attached to the endoscope 12 can be reliably removed or their pathogenicity can be eliminated, while excessive disinfection of the endoscope 12 is prevented. As a result, the safety and reliability of the endoscope 12 can be enhanced. In addition, a waste of the disinfectant solution can be suppressed, leading to a reduction in cost.

In the eighth operation example, as described above, the type of the used disinfectant solution is different between the first and second disinfection processes. The presently disclosed subject matter is not limited to this example, and the concentration or temperature of the used disinfectant solution may be different between the first and second disinfection processes.

In the mode of changing the concentration of the disinfectant solution, in the first disinfection process, the endoscope 12 is disinfected using a low-concentration disinfectant solution, whereas in the second cleaning process, the endoscope 12 is disinfected using a disinfectant solution having a concentration higher than that of the disinfectant solution used in the first disinfection process.

In the mode of changing the temperature of the disinfectant solution, in the first disinfection process, the endoscope 12 is disinfected using a disinfectant solution having a predetermined temperature, whereas in the second disinfection process, the endoscope 12 is disinfected using a disinfectant solution having a temperature higher than that in the first disinfection process.

According to still another mode, a duration time for which the endoscope 12 is immersed in the disinfectant solution (that is, disinfection duration time) may be made different between the first and second disinfection duration times. That is, in the first disinfection process, the endoscope 12 is immersed in the disinfectant solution for a predetermined time, whereas in the second disinfection process, the endoscope 12 is immersed therein for a time longer than that in the first disinfection process.

In any modes, similarly to the mode of using the different two types of disinfectant solutions, the endoscope 12 can be reliably disinfected with damage of the endoscope 12 due to the disinfection being suppressed, and the cost of the disinfectant solution can be reduced.

Note that, in the present embodiment, the management server 20 holds the cleaning information, but the presently disclosed subject matter is not limited thereto. For example, the cleaning information on at least the previous cleaning is held in the RFID tag 14, and data may be exchanged with the cleaning apparatus 30 without the intermediation of the management server 20, by reading the held information by the RFID reader 40 of the cleaning apparatus 30.

Alternatively, the number of times (N, Q, Q_{A}, Q_{B}) of previous cleaning and the endoscope-usable time length are held in the RFID tag 14, and data may be exchanged with the endoscope processor 10 without the intermediation of the management server 20, by reading the held information by an RFID reader (not illustrated) of the endoscope processor 10.

Hereinabove, the endoscope cleaning system and the endoscope cleaning method according to the presently disclosed subject matter have been described in detail, and the presently disclosed subject matter is not limited to the above-mentioned examples. As a matter of course, the presently disclosed subject matter can be variously improved or modified within a range not departing from the gist of the presently disclosed subject matter.

<Note>

As is apparent from the above detailed description of the embodiments, the present specification encompasses disclosure of various technical ideas including the following aspects.

(Aspect 1): An endoscope cleaning system including: a first cleaning device that cleans an endoscope; a cleaning evaluation device that determines whether or not a cleaning level of the endoscope cleaned by the first cleaning device satisfies a predetermined criterion; and a second cleaning device that cleans the endoscope according to a method different from that of the first cleaning device, if the cleaning evaluation device determines that the cleaning level of the endoscope does not satisfy the predetermined criterion.

According to this aspect, the cleaning evaluation is performed for determining whether or not the cleaning level of the endoscope after the cleaning satisfies the predetermined criterion, and if the cleaning level does not satisfy the predetermined criterion, the endoscope is re-cleaned according to the different method. Accordingly, even in the case where the cleaning of the endoscope is insufficient, contamination attached to the endoscope can be reliably removed, while excessive cleaning of the endoscope is prevented. This makes it possible to reliably secure the cleaning level of the endoscope, and a sufficient effect can be obtained in the subsequent disinfection.

(Aspect 2): The endoscope cleaning system according to Aspect 1, in which the second cleaning device cleans the endoscope with at least one condition of a type, concentration, and temperature of a cleaning solution being different from that of the first cleaning device.

According to this aspect, it is effective to re-clean the endoscope with at least one condition of the type, concentration, and temperature of the cleaning solution being different.

(Aspect 3): The endoscope cleaning system according to Aspect 1 or 2, in which the second cleaning device cleans the endoscope with a cleaning duration time being different from that of the first cleaning device.

According to this aspect, it is effective to re-clean the endoscope with the cleaning duration time being different.

(Aspect 4): The endoscope cleaning system according to any one of Aspects 1 to 3, in which the cleaning evaluation device includes a degree-of-contamination detection device that detects a degree of contamination of the endoscope using an ATP measurement method.

According to this aspect, it is preferable to detect the degree of contamination of the endoscope using the ATP measurement method, and it is thus possible to promptly and accurately determine whether or not the cleaning level of the endoscope satisfies the predetermined criterion.

(Aspect 5): The endoscope cleaning system according to any one of Aspects 1 to 4, further including a pre-cleaning evaluation device that determines a cleaning level of the endoscope before the cleaning by the first cleaning device.

According to this aspect, it is possible to evaluate whether or not preliminary cleaning of the endoscope is appropriately performed.

(Aspect 6): The endoscope cleaning system according to Aspect 5, further including a display device that displays a determination result of the pre-cleaning evaluation device.

This aspect enables a user (person in charge of cleaning) to easily understand whether or not the preliminary cleaning of the endoscope is appropriately performed.

(Aspect 7): The endoscope cleaning system according to any one of Aspects 1 to 6, further including: a first disinfection device that disinfects the endoscope; a disinfection evaluation device that determines whether or not a disinfection level of the endoscope disinfected by the first disinfection device satisfies a predetermined criterion; and a second disinfection device that disinfects the endoscope according to a method different from that of the first disinfection device, if the disinfection evaluation device determines that the disinfection level of the endoscope does not satisfy the predetermined criterion.

According to this aspect, not only the cleaning evaluation for the endoscope but also the disinfection evaluation therefor is performed. Accordingly, even in the case where the disinfection of the endoscope is insufficient, bacteria remaining in the endoscope can be reliably removed or their pathogenicity can be eliminated, while excessive disinfection of the endoscope is prevented. This makes it possible to reliably secure the disinfection level as well as the cleaning level of the endoscope, and the safety and reliability of the endoscope can be enhanced.

(Aspect 8): The endoscope cleaning system according to Aspect 7, in which the second disinfection device disinfects the endoscope with at least one condition of a type, concentration, and temperature of a disinfectant solution being different from that of the first disinfection device.

According to this aspect, it is effective to re-disinfect the endoscope with at least one condition of the type, concentration, and temperature of the disinfectant solution being different.

(Aspect 9): The endoscope cleaning system according to Aspect 7 or 8, in which the second disinfection device disinfects the endoscope with a disinfection duration time being different from that of the first disinfection device.

According to this aspect, it is effective to re-disinfect the endoscope with the disinfection duration time being different.

(Aspect 10): The endoscope cleaning system according to any one of Aspects 7 to 9, in which the disinfection evaluation device includes a living bacteria detection device that detects living bacteria in the endoscope using a fluorescence staining and filtering method.

According to this aspect, it is preferable to detect the living bacteria in the endoscope using the fluorescence staining and filtering method, and it is thus possible to promptly and accurately determine whether or not the disinfection level of the endoscope satisfies the predetermined criterion.

(Aspect 11): An endoscope cleaning method including: a first cleaning step of cleaning an endoscope; a cleaning evaluation step of determining whether or not a cleaning level of the endoscope cleaned in the first cleaning step satisfies a predetermined criterion; and a second cleaning step of cleaning the endoscope according to a method different from that of the first cleaning step, if it is determined in the cleaning evaluation step that the cleaning level of the endoscope does not satisfy the predetermined criterion.
(Aspect 12): The endoscope cleaning method according to Aspect 11, in which the second cleaning step includes cleaning the endoscope with at least one condition of a type, concentration, and temperature of a cleaning solution being different from that of the first cleaning step.
(Aspect 13): The endoscope cleaning method according to Aspect 11 or 12, in which the second cleaning step includes cleaning the endoscope with a cleaning duration time being different from that of the first cleaning step.
(Aspect 14): The endoscope cleaning method according to any one of Aspects 11 to 13, in which the cleaning evaluation step includes a degree-of-contamination detection step of detecting a degree of contamination of the endoscope using an ATP measurement method.
(Aspect 15): The endoscope cleaning method according to any one of Aspects 11 to 14, further including a pre-cleaning evaluation step of determining a cleaning level of the endoscope before the cleaning in the first cleaning step.
(Aspect 16): The endoscope cleaning method according to Aspect 15, further including a display step of displaying a determination result of the pre-cleaning evaluation step.
(Aspect 17): The endoscope cleaning method according to any one of Aspects 11 to 16, further including: a first disinfection step of disinfecting the endoscope; a disinfection evaluation step of determining whether or not a disinfection level of the endoscope disinfected in the first disinfection step satisfies a predetermined criterion; and a second disinfection step of disinfecting the endoscope according to a method different from that of the first disinfection step, if it is determined in the disinfection evaluation step that the disinfection level of the endoscope does not satisfy the predetermined criterion.
(Aspect 18): The endoscope cleaning method according to Aspect 17, in which the second disinfection step includes disinfecting the endoscope with at least one condition of a type, concentration, and temperature of a disinfectant solution being different from that of the first disinfection step.
(Aspect 19): The endoscope cleaning method according to Aspect 17 or 18, in which the second disinfection step includes disinfecting the endoscope with a disinfection duration time being different from that of the first disinfection step.
(Aspect 20): The endoscope cleaning method according to any one of Aspects 17 to 19, in which the disinfection evaluation step includes a living bacteria detection step of detecting living bacteria in the endoscope using a fluorescence staining and filtering method.
(Aspect 21): An endoscope cleaning system including: a cleaning device that cleans an endoscope; a cleaning evaluation device that determines whether or not a cleaning level of the endoscope cleaned by the cleaning device satisfies a predetermined criterion; a re-cleaning instruction device that gives an instruction to re-clean the endoscope, if the cleaning evaluation device determines that the cleaning level of the endoscope does not satisfy the predetermined criterion; an endoscope-usable time length setting device that sets an endoscope-usable time length in accordance with the number of times of cleaning of the endoscope that is performed until the cleaning evaluation device determines that the cleaning level of the endoscope satisfies the predetermined criterion; an endoscope-usable time length determination device that determines whether or not an elapsed time since the cleaning of the endoscope exceeds the endoscope-usable time length; and an endoscope-use prohibition device that prohibits use of the endoscope if it is determined that the elapsed time exceeds the endoscope-usable time length.

According to this aspect, the cleaning evaluation is performed for determining whether or not the cleaning level of the endoscope after the cleaning satisfies the predetermined criterion. The endoscope-usable time length is set in accordance with the number of times of cleaning until the cleaning evaluation is passed. If the elapsed time since the cleaning of the endoscope 12 exceeds the endoscope-usable time length, the use of the endoscope is prohibited, and the start of the endoscopic examination is disabled. This makes it possible to easily and reliably prevent the endoscope from being used beyond the endoscope-usable time length, and the safety and reliability of the endoscope can be enhanced.

(Aspect 22): The endoscope cleaning system according to Aspect 21, in which the endoscope-usable time length setting device sets the endoscope-usable time length to be shorter as the number of times of cleaning is larger.

As in this aspect, it is preferable that the usable time length of the endoscope with a large number of times of cleaning until the cleaning evaluation is passed, that is, the endoscope to which contamination is easily attached be set to be short. This makes it possible to reliably secure the cleanliness of the endoscope.

(Aspect 23): The endoscope cleaning system according to Aspect 21 or 22, further including an additional cleaning instruction device that gives an instruction to additionally clean the endoscope, if the number of times of cleaning of the endoscope that is performed until the cleaning evaluation device determines that the cleaning level of the endoscope satisfies the predetermined criterion is more than a predetermined number of times.

As in this aspect, in order to more reliably secure the cleanliness, it is preferable to additionally clean the endoscope in teens of preventive maintenance, even if the cleaning evaluation is passed.

(Aspect 24): The endoscope cleaning system according to any one of Aspects 21 to 23, further including: a cleaning history management device that manages history information on the cleaning of the endoscope; a cleaning history acquisition device that acquires, from the cleaning history management device, the number of times of previous cleaning of the endoscope that is performed until the cleaning evaluation device determines during the previous cleaning that the cleaning level of the endoscope satisfies the predetermined criterion; and a cleaning evaluation omission device that causes the cleaning evaluation device to omit the determination in accordance with the number of times of previous cleaning.

As in this aspect, the cleaning evaluation for the endoscope is omitted in accordance with the number of times of previous cleaning, whereby the time required for the cleaning evaluation can be reduced, leading to improved efficiency in entire processing.

(Aspect 25): The endoscope cleaning system according to Aspect 24, in which the cleaning evaluation omission device causes, if the number of times of previous cleaning is less than a predetermined number of times, the cleaning evaluation device to perform the determination after the endoscope is cleaned by the cleaning device, and causes, if the number of times of previous cleaning is equal to or more than the predetermined number of times, the cleaning evaluation device to omit the determination until the endoscope is cleaned by the cleaning device at least twice.

This aspect is a preferable example when the cleaning evaluation for the endoscope is omitted in accordance with the number of times of previous cleaning.

(Aspect 26): An endoscope cleaning method including: a cleaning step of cleaning an endoscope; a cleaning evaluation step of determining whether or not a cleaning level of the endoscope cleaned in the cleaning step satisfies a predetermined criterion; a re-cleaning instruction step of giving an instruction to re-clean the endoscope, if it is determined in the cleaning evaluation step that the cleaning level of the endoscope does not satisfy the predetermined criterion; an endoscope-usable time length setting step of setting an endoscope-usable time length in accordance with the number of times of cleaning of the endoscope that is performed until it is determined in the cleaning evaluation step that the cleaning level of the endoscope satisfies the predetermined criterion; an endoscope-usable time length determination step of determining whether or not an elapsed time since the cleaning of the endoscope exceeds the endoscope-usable time length; and an endoscope-use prohibition step of prohibiting use of the endoscope if it is determined that the elapsed time exceeds the endoscope-usable time length.
(Aspect 27): The endoscope cleaning method according to Aspect 26, in which the endoscope-usable time length setting step includes setting the endoscope-usable time length to be shorter as the number of times of cleaning is larger.
(Aspect 28): The endoscope cleaning method according to Aspect 26 or 27, further including an additional cleaning instruction step of giving an instruction to additionally clean the endoscope, if the number of times of cleaning of the endoscope that is performed until it is determined in the cleaning evaluation step that the cleaning level of the endoscope satisfies the predetermined criterion is more than a predetermined number of times.
(Aspect 29): The endoscope cleaning method according to any one of Aspects 26 to 28, further including: a cleaning history management step of managing history information on the cleaning of the endoscope; a cleaning history acquisition step of acquiring, from the history information managed in the cleaning history management step, the number of times of previous cleaning of the endoscope that is performed until it is determined in the cleaning evaluation step during the previous cleaning that the cleaning level of the endoscope satisfies the predetermined criterion; and a cleaning evaluation omission step of omitting the determination in the cleaning evaluation step in accordance with the number of times of previous cleaning.
(Aspect 30): The endoscope cleaning method according to Aspect 29, in which the cleaning evaluation omission step includes causing, if the number of times of previous cleaning is less than a predetermined number of times, the determination in the cleaning evaluation step to be performed after the endoscope is cleaned in the cleaning step, and omitting, if the number of times of previous cleaning is equal to or more than the predetermined number of times, the determination in the cleaning evaluation step until the endoscope is cleaned in the cleaning step at least twice.
(Aspect 31): An endoscope cleaning system including: a first cleaning device that cleans an endoscope; a second cleaning device that cleans the endoscope according to a method different from that of the first cleaning device; a cleaning evaluation device that determines whether or not a cleaning level of the endoscope cleaned by one of the first cleaning device and the second cleaning device satisfies a predetermined criterion; a re-cleaning instruction device that gives an instruction to re-clean the endoscope, if the cleaning evaluation device determines that the cleaning level of the endoscope does not satisfy the predetermined criterion; a cleaning history management device that manages, for each cleaning device, the number of times of cleaning of the endoscope that is performed until the cleaning evaluation device determines that the cleaning level of the endoscope satisfies the predetermined criterion; a cleaning history acquisition device that acquires, for each cleaning device, the number of times of previous cleaning when the endoscope is cleaned last time; and a selection device that selects a cleaning device to be used for cleaning the endoscope from among the first cleaning device and the second cleaning device, on a basis of the number of times of previous cleaning acquired by the cleaning history acquisition device.

According to this aspect, the two types of cleaning devices using different cleaning methods are provided, and the cleaning device to be used for cleaning the endoscope is selected from among the two types of cleaning devices in accordance with the number of times of previous cleaning. In this way, the cleaning device is selected on the basis of the number of times of previous cleaning, whereby the endoscope can be cleaned by the cleaning device suited to the state of the endoscope (the degree of difficulty in removing contamination). In addition, after the cleaning is performed by the respective cleaning devices, the cleaning evaluation is performed for determining whether or not the cleaning level of the endoscope satisfies the predetermined criterion. If the cleaning level does not satisfy the predetermined criterion, the instruction to re-clean the endoscope is given. Accordingly, even in the case where the cleaning of the endoscope is insufficient, contamination attached to the endoscope can be reliably removed, while excessive cleaning of the endoscope is prevented. This makes it possible to reliably secure the cleaning level of the endoscope, and a sufficient effect can be obtained in the subsequent disinfection. In addition, the service life of the endoscope can be prolonged with damage of the endoscope due to the cleaning being suppressed.

(Aspect 32): The endoscope cleaning system according to Aspect 31, in which the first cleaning device cleans the endoscope according to a method that is less harmful to the endoscope than that of the second cleaning device, and in which the selection device selects the first cleaning device if the number of times of previous cleaning by the first cleaning device is equal to or less than a predetermined number of times and the number of times of previous cleaning by the second cleaning device is 0.

This aspect is a preferable example when the cleaning device is selected on the basis of the number of times of previous cleaning.

(Aspect 33): The endoscope cleaning system according to Aspect 32, in which the selection device selects the second cleaning device if the number of times of cleaning by the first cleaning device reaches a predetermined number of times, and in which the cleaning by the second cleaning device is repeated until the cleaning evaluation device determines that the cleaning level of the endoscope satisfies the predetermined criterion.

As in this aspect, if it is determined that the cleaning by the first cleaning device is insufficient, the second cleaning device is selected to perform cleaning, whereby a cleaning effect on the endoscope can be enhanced.

(Aspect 34): The endoscope cleaning system according to Aspect 32 or 33, in which a first cleaning solution used by the first cleaning device is less harmful to the endoscope than a second cleaning solution used by the second cleaning device.

As in this aspect, it is preferable that the first cleaning solution used by the first cleaning device be less harmful to the endoscope than the second cleaning solution used by the second cleaning device. It is possible to suppress damage of the endoscope when the endoscope is cleaned using the first cleaning solution.

(Aspect 35): The endoscope cleaning system according to any one of Aspects 32 to 34, in which a concentration of the first cleaning solution used by the first cleaning device is lower than a concentration of the second cleaning solution used by the second cleaning device.

As in this aspect, it is preferable that the concentration (cleaning agent concentration) of the first cleaning solution be lower than the concentration of the second cleaning solution. It is possible to suppress damage of the endoscope when the endoscope is cleaned using the first cleaning solution.

(Aspect 36): An endoscope cleaning method including: a first cleaning step of cleaning an endoscope by a first cleaning device; a second cleaning step of cleaning the endoscope by a second cleaning device according to a cleaning method different from that of the first cleaning step; a cleaning evaluation step of determining whether or not a cleaning level of the endoscope cleaned in one of the first cleaning step and the second cleaning step satisfies a predetermined criterion; a re-cleaning instruction step of giving an instruction to re-clean the endoscope, if it is determined in the cleaning evaluation step that the cleaning level of the endoscope does not satisfy the predetermined criterion; a cleaning history management step of managing, for each cleaning device, the number of times of cleaning of the endoscope that is performed until it is determined in the cleaning evaluation step that the cleaning level of the endoscope satisfies the predetermined criterion; a cleaning history acquisition step of acquiring, for each cleaning device, the number of times of previous cleaning when the endoscope is cleaned last time; and a selection step of selecting a device to be used for cleaning the endoscope from among the first cleaning device and the second cleaning device, on a basis of the number of times of previous cleaning acquired in the cleaning history acquisition step.
(Aspect 37): The endoscope cleaning method according to Aspect 36, in which the first cleaning step includes cleaning the endoscope according to a method that is less harmful to the endoscope than that of the second cleaning step, and in which the selection step includes selecting the first cleaning step if the number of times of previous cleaning in the first cleaning step is equal to or less than a predetermined number of times and the number of times of previous cleaning in the second cleaning step is 0.
(Aspect 38): The endoscope cleaning method according to Aspect 37, in which if the number of times of cleaning by the first cleaning device reaches a predetermined number of times, the cleaning by the second cleaning device is repeated until it is determined in the cleaning evaluation step that the cleaning level of the endoscope satisfies the predetermined criterion.
(Aspect 39): The endoscope cleaning method according to Aspect 37 or 38, in which a first cleaning solution used in the first cleaning step is less harmful to the endoscope than a second cleaning solution used in the second cleaning step.
(Aspect 40): The endoscope cleaning method according to any one of Aspects 37 to 39, in which a concentration of the first cleaning solution used in the first cleaning step is lower than a concentration of the second cleaning solution used in the second cleaning step.

1. An endoscope cleaning system comprising:
a first cleaning device configured to clean an endoscope;
a second cleaning device configured to clean the endoscope according to a method different from that of the first cleaning device; and
a cleaning evaluation device configured to determine whether or not a cleaning level of the endoscope cleaned by one of the first cleaning device and the second cleaning device satisfies a predetermined criterion, wherein
one of the first cleaning device and the second cleaning device cleans the endoscope in accordance with a determination result of the cleaning evaluation device.

2. An endoscope cleaning system comprising:
a first cleaning device configured to clean an endoscope;
a cleaning evaluation device configured to determine whether or not a cleaning level of the endoscope cleaned by the first cleaning device satisfies a predetermined criterion; and
a second cleaning device configured to clean the endoscope according to a method different from that of the first cleaning device, if the cleaning evaluation device determines that the cleaning level of the endoscope does not satisfy the predetermined criterion.

3. The endoscope cleaning system according to claim 2, wherein
the second cleaning device cleans the endoscope with at least one condition of a type, concentration, and temperature of a cleaning solution being different from that of the first cleaning device.

4. The endoscope cleaning system according to claim 2, wherein
the second cleaning device cleans the endoscope with a cleaning duration time being different from that of the first cleaning device.

5. The endoscope cleaning system according to claim 2, wherein
the cleaning evaluation device comprises a degree-of-contamination detection device configured to detect a degree of contamination of the endoscope using an ATP measurement method.

6. The endoscope cleaning system according to claim 2, further comprising:
a first disinfection device configured to disinfect the endoscope;
a disinfection evaluation device configured to determine whether or not a disinfection level of the endoscope disinfected by the first disinfection device satisfies a predetermined criterion; and
a second disinfection device configured to disinfect the endoscope according to a method different from that of the first disinfection device, if the disinfection evaluation device determines that the disinfection level of the endoscope does not satisfy the predetermined criterion.

7. The endoscope cleaning system according to claim 6, wherein
the second disinfection device disinfects the endoscope with at least one condition of a type, concentration, and temperature of a disinfectant solution being different from that of the first disinfection device.

8. The endoscope cleaning system according to claim 6, wherein
the second disinfection device disinfects the endoscope with a disinfection duration time being different from that of the first disinfection device.

9. The endoscope cleaning system according to claim 6, wherein
the disinfection evaluation device comprises a living bacteria detection device configured to detect living bacteria in the endoscope using a fluorescence staining and filtering method.

10. An endoscope cleaning method comprising:
a first cleaning step of cleaning an endoscope;
a cleaning evaluation step of determining whether or not a cleaning level of the endoscope cleaned in the first cleaning step satisfies a predetermined criterion; and
a second cleaning step of cleaning the endoscope according to a method different from that of the first cleaning step, if it is determined in the cleaning evaluation step that the cleaning level of the endoscope does not satisfy the predetermined criterion.

11. The endoscope cleaning method according to claim 10, wherein,
in the second cleaning step, cleaning of the endoscope is performed with at least one condition of a type, concentration, and temperature of a cleaning solution being different from that of the first cleaning step.

12. The endoscope cleaning method according to claim 10, wherein,
in the second cleaning step, cleaning of the endoscope is performed with a cleaning duration time being different from that of the first cleaning step.

13. The endoscope cleaning method according to claim 10, further comprising:
a first disinfection step of disinfecting the endoscope;
a disinfection evaluation step of determining whether or not a disinfection level of the endoscope disinfected in the first disinfection step satisfies a predetermined criterion; and
a second disinfection step of disinfecting the endoscope according to a method different from that of the first disinfection step, if it is determined in the disinfection evaluation step that the disinfection level of the endoscope does not satisfy the predetermined criterion.

14. The endoscope cleaning method according to claim 13, wherein,
in the second disinfection step, disinfection of the endoscope is performed with at least one condition of a type, concentration, and temperature of a disinfectant solution being different from that of the first disinfection step.

15. The endoscope cleaning method according to claim 13, wherein,
in the second disinfection step, disinfection of the endoscope is performed with a disinfection duration time being different from that of the first disinfection step.

16. An endoscope cleaning system comprising:
a first cleaning device configured to clean an endoscope;
a second cleaning device configured to clean the endoscope according to a method different from that of the first cleaning device;
a cleaning evaluation device configured to determine whether or not a cleaning level of the endoscope cleaned by one of the first cleaning device and the second cleaning device satisfies a predetermined criterion;
a re-cleaning instruction device configured to give an instruction to re-clean the endoscope, if the cleaning evaluation device determines that the cleaning level of the endoscope does not satisfy the predetermined criterion;
a cleaning history management device configured to manage, for each cleaning device, the number of times of cleaning of the endoscope that is performed until the cleaning evaluation device determines that the cleaning level of the endoscope satisfies the predetermined criterion;
a cleaning history acquisition device configured to acquire, for each cleaning device, the number of times of previous cleaning when the endoscope is cleaned last time; and
a selection device configured to select a cleaning device to be used for cleaning the endoscope from among the first cleaning device and the second cleaning device, on a basis of the number of times of previous cleaning acquired by the cleaning history acquisition device.

17. The endoscope cleaning system according to claim 16, wherein:
the first cleaning device cleans the endoscope according to a method that is less harmful to the endoscope than that of the second cleaning device, and
the selection device selects the first cleaning device if the number of times of previous cleaning by the first cleaning device is equal to or less than a predetermined number of times and the number of times of previous cleaning by the second cleaning device is 0.

18. The endoscope cleaning system according to claim 17, wherein:
the selection device selects the second cleaning device if the number of times of cleaning by the first cleaning device reaches a predetermined number of times, and
the cleaning by the second cleaning device is repeated until the cleaning evaluation device determines that the cleaning level of the endoscope satisfies the predetermined criterion.

19. An endoscope cleaning method comprising:
a first cleaning step of cleaning an endoscope by a first cleaning device;
a second cleaning step of cleaning the endoscope by a second cleaning step according to a cleaning method different from that of the first cleaning step;
a cleaning evaluation step of determining whether or not a cleaning level of the endoscope cleaned in one of the first cleaning step and the second cleaning step satisfies a predetermined criterion;
a re-cleaning instruction step of giving an instruction to re-clean the endoscope, if it is determined in the cleaning evaluation step that the cleaning level of the endoscope does not satisfy the predetermined criterion;
a cleaning history management step of managing, for each cleaning device, the number of times of cleaning of the endoscope that is performed until it is determined in the cleaning evaluation step that the cleaning level of the endoscope satisfies the predetermined criterion;
a cleaning history acquisition step of acquiring, for each cleaning device, the number of times of previous cleaning when the endoscope is cleaned last time; and
a selection step of selecting a cleaning device to be used for cleaning the endoscope from among the first cleaning device and the second cleaning device, on a basis of the number of times of previous cleaning acquired in the cleaning history acquisition step.

20. The endoscope cleaning method according to claim 19, wherein,
in the first cleaning step, cleaning of the endoscope is performed according to a method that is less harmful to the endoscope than that of the second cleaning step, and,
in the selection step, the first cleaning device is selected if the number of times of previous cleaning by the first cleaning device is equal to or less than a predetermined number of times and the number of times of previous cleaning by the second cleaning device is 0.
